(19) United States
(12) Patent Application Publication
(10) Pub. No.: US 2016/0044922 A1
(43) Pub. Date: Feb. 18, 2016

(54) Control of Ectoparasites

(71) Applicant: Bayer Animal Health GmbH

(72) Inventor: Michael Crawford, St. Louis, MO (US)

(73) Assignee: Bayer Animal Health GmbH

(21) Appl. No.: 14/462,316

(22) Filed: Aug. 18, 2014

(51) Int. Cl. A01N 43/56

(52) U.S. Cl. CPC A01N 43/56

(57) ABSTRACT

Disclosed is a method of controlling ectoparasites that infest companion and livestock animals by applying to the animal an effective amount of 4-tert-butylphenethyl quinazolin-4-yl either or 4-chloro-5-ethyl-2-methyl-N-[(4-tert-butylphenyl)methyl]pyrazole-3-carboxamide or 5-chloro-N-[2-[4(2-ethoxyethyl)-2,3-dimethylphenoxy]ethyl]-6-ethyl-4-pyrimidinamine.

### BACKGROUND

In the rearing of animals, such as companion animals and livestock, ectoparasites cause enormous losses, including economic losses, particularly because many ectoparasites can act as disease vectors.

The control of animal ectoparasites is an ongoing challenge. For example, numerous strains of ticks have developed resistance to a wide range of pesticides such as arsenic, hexachlorohexane, camphechlor, DDT, pyrethrines, carbamates and organophosphorous compounds despite the fact that these compounds have varied modes of action and several distinct primary sites of attack in the ectoparasite. It is therefore generally accepted that it is highly desirable to develop and commercialize additional active agents with new modes of action for ectoparasite control.

Compounds harboring a quinazole, pyrazole or pyrimidine core are well known for their fungicidal, insecticidal and miticidal use in the crop chemistry applications (e.g., U.S. Pat. No. 5,411,963). However several reports have indicated that fenazaquin and tebufenpyrad have limited spectrum of activity against insect pests as well as relatively low toxicity to beneficial mite species under normal use (Pest Manag Sci 2005 61(2):103-10).

### SUMMARY

Described herein are methods for preventing and/or repressing ectoparasites of animals. The methods include the application to the animal of an effective amount of a composition that includes: 4-tert-butylphenethyl quinazolin-4-yl ether (fenazaquin), 4chloro-5-ethyl-2-methyl-N-[(4-tert-butylphenyl)methyl]pyrazole-3-carboxamide (tebufenpyrad), 5-chloro-N-[2-[4-(2-ethoxethyl)-2,3-dimethylphenoxy]ethyl]-6-ethyl-4-pyrimidinamine (pyrimidifen). Fenazaquin, tebufenpyrad and pyrimidifen are thought to affect metabolism by inhibiting the mitochondrial electron transport chain by binding with Complex I at co-enzyme Q₀ and represent a novel mode of action for ectoparasite control in animal health.

The unexpected anti-tick and anti-flea properties of certain mitochondrial electron transport inhibitors are of considerable significance since there are relatively few agriculture pesticides that can be effectively be used against ectoparasites of animals.

Compositions and processes for controlling ectoparasites of animals are described herein. The methods entail the use of compositions that include: 4tert-butylphenethyl quinazolin-4-yl ether (Formula I), 4-chloro-5-ethyl-2-methyl-N-[(4-tert-butylphenyl)methyl]pyrazole-3carboxamide (Formula II), 5-chloro-N-[2-[4-(2-ethoxyethyl)-2,3-dimethylphenoxy]ethyl]-6-ethyl-4-pyrimidinamine disclosed as formula III, to control ticks, mites, fleas, flies, and lice that infest animals.

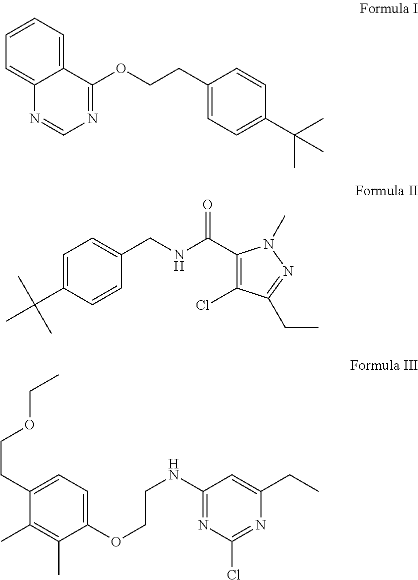

The compounds in Formula I, Formula II and Formula III are suitable for controlling arthropods which attack agricultural livestock such as, for example, cattle sheep, goats, horses, pigs, donkeys, camels, buffaloes, rabbits, chickens, turkeys, ducks, geese, other domestic animals such as, for example, dogs, cats, caged birds, aquarium fish and so-called experimental animals such as, for example, hamsters, guinea pigs, rats, and mice. By controlling these anthropods, cases of death and reductions in productivity (for meat, milk, wool, hides, eggs, and the like) can be lessened, so that more economical and simpler animal husbandry is possible.

The details of one or more embodiments of the invention are set forth in the accompanying description below. Other features, objects, and advantages of the invention will be apparent from the description and from the claims.

### DETAILED DESCRIPTION

Several compounds having activity as mitochondrial complex 1 inhibitors were commercialized in the 1990s for the purpose of protecting crops and other plants from predation by plant pests such as spider mites (e.g., two spotted spider mite) or rust mites (e.g., apple rust mite). These compounds include fenazaquin (4-tert-butylphenyl quinazolin-4-yl ether), tebufenpyrad (4-chloro-5-ethyl-2-methyl-N-[(4-tert-butylphenethyl)methyl]pyrazole-3-carboxamide), pyrimidifen (5-chloro-N-[2-[4-(2-ethoxyethyl)-2,3-dimethylphenoxy]ethyl]-6-ethyl-4-pyrimidinamine), fenpyroximate (tert-butyl 4-[[(1,3-dimethyl-5-phenoxy-pyrazol-4-yl)methylideneamino]oxymethyl]benzoate), pyridaben (4-chloro-2-tert-butyl-5-[(4-tert-butylphenyl)methylsulfanyl]pyridazin-3-one) and tolfenpyrad (4-chloro-3-ethyl-1-methyl-N-[4-(p-tolyloxy)benzyl]pyrazole-5-carboximide).

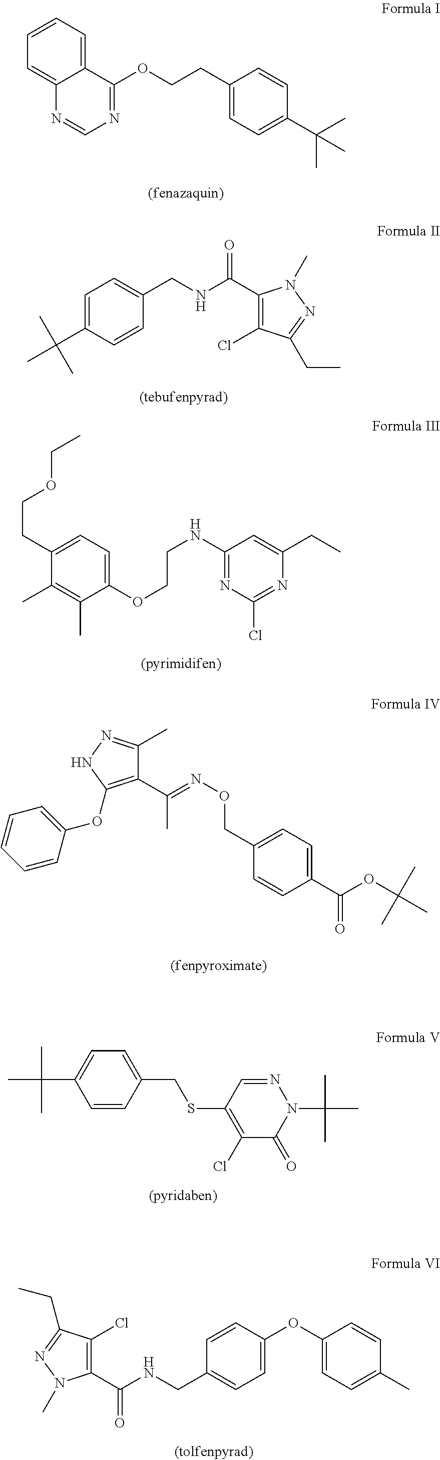

Despite acting at a conserved site (coenzyme Q₀ of Complex I) and interfering with an essential process (mitochondrial electron transport) these pesticides nonetheless show surprising and unpredictable species selectivity. Although used primarily as acaricides against plant parasitic mites, fenazaquin, fempyroximate, pyridaben and tebufenpyrad have minimal impact on predatory mites and many beneficial insects under field conditions (Pest Manag Sci 2005 61(2):103-10).

A specific example of the large spades dependent differences in potency of complex I inhibitors is seen for fenazaquin in a study by Hackler et al. Fenazaquin is highly active against cotton aphids (LC₅₀ of 2.6 ppm) and against mosquito larvae of (LC₅₀ of 0725 ppm) but has low potency against the against cabbage looper (LC₅₀ 188 ppm) and greater than 400 ppm activity against both southern corn rootworm and tobacco budworm (Hackler et al. 1998 Development of broad-spectrum insecticide activity from a miticide. In: Synthesis and Chemistry of Agrochemicals V (Bakeret al.; eds), American Chemical Society, Washington D.C., pp. 147-150). These species sensitivity differences could be due to intrinsic activity differences (i.e., active site changes), metabolism differences and/or penetration differences. For example, fenazaquin is extensively metabolized by the tobacco bud worm, which may explain the poor efficacy against this species. Additionally fenazaquin is degraded more extensively by rat liver microsomes than by trout liver microsomes which may partially explain the higher toxicity of the compound to fish than to mammals. At present, these species-dependent differences in the interactions of the compounds with the active sites, or metabolism or penetration differences are impossible to predict a priori.

Surprisingly we have found that fenazquin (4-tert-butylphenethyl quinazolin-4-yl ether) and contain other mitochondrial complex I inhibitors are active on fleas and ticks, two distantly related groups of arthropods that are both commercially important ectoparasites in animal husbandry.

The compounds 4-tert-butylphenethyl quinazolin-4-yl ether, 4-chloro-5-ethyl-2-methyl-N-[(4-tert-butylphenyl)methyl]pyrazole-3-carboxamide, and 5-chloro-N-[2- [4-(2-ethoxyethyl)-2,3-dimethylphenoxy]ethyl]-6-ethyl-4-pyrimidinamine, are contemplated to be active against animal parasites (ectoparasites) such as hard ticks, soft ticks, mange mites, harvest mites, lice, hair lice, bird lice and fleas. These parasites include the ectoparasites of the order Acari of the family Ixodidae, e.g., the cattle ticks such as Boophilus spp e.g. Boophilus microplus, Boophilus decoloratus and Boophilus annulatus; Rhipicephalus spp such as Rhipicephalus sanguineus, Rhipicephalus appendiculatus, Rhipicephalus pulchellus and Rhipicephalus evertsi; Hyalomma spp such as Hyalomma truncatum, Hyalomma rufipes, Hyalomma detritum, Hyalomma marginatum, Hyalomma dromedaril and Hyalomma anatolicum excavatum; Dermacentor species such as Dermacentor variabilis and Dermacentor andersoni; Amblyomma spp such as Amblyomma variegatum, Amblyomma herbraeum, Amblyomma pomposum, Amblyomma americanum, Amblyomma cayennenese, Amblyomma maculatum, Amblyomma gemma and Amblyomma lepidhon; of the family Argasidae, e.g., Otobius spp such as Otobius megnini and Ornithodores spp such as Ornithodoros savignyi, Ornithodoros lahorensis and Ornithodoros tholozani; of the family Psoroptidae, e.g., Psoroptes ovis and Psoroptes equi; and of the family Sarcopidae e.g. Sarcoptes bovis or Sarcoptes scabici; ectoprasites of the order Diptera, which includes biting and sucking flies; ectoparasites of the order Phthiraptera, which includes sucking and chewing lice; and ectoparasites of the order Siphonaptera, including but not limited to the cat flea (Ctenocephalides felis) and the dog flea (Ctenocephalides canis).

The active compounds can be enterally administered in the form of, for example, tablets, capsules, potions, drenches, granules, pastes, boluses, the feed-through method, suppositories. The compounds can be parenterally administered such as, for example, by injections (intramuscularly, subcutaneously, intravenously, intraperitoneally and the like). The compounds can also be administered as implants, by nasal administration, by dermal administration in the form of, for example, immersing or dipping, spraying, pouring-on, spotting-on, washing, dusting, and with the aid of active-compound-comprising molded articles such as collars, ear tags, tail tags, limb bands, halters, marking devices and the like.

The active compound content of the use forms prepared from the commercially available formulations can vary within wide limits. The active compound concentration of the use forms can be from 0.0000001 to 95% by weight of active compound, preferably between 0.0001 and 10% by weight.

When used for cattle, poultry, domestic animals and the like, the active compound combinations can be applied as formulations (for example powders, emulsions, flowables) comprising the active compounds in an amount of 1 to 80% by weight, either directly or after 100- to 10,000-fold dilution or they may be used as a chemical dip.

The compound of formula I, II and III are applied to the ectoparasites of the order Acari, in free base form or in agriculturally acceptable acid addition salt form, e.g., as hydrochloride or acetate, by topical treatment of the animals, e.g., by dusting, by dipping or by spray treatments with dilute aqueous form. The compound of formula I, II and III are preferably used in free base form. The degree of dilution may vary although preferably a concentration in the range of 0.01 to 5.0%, particularly of 0.02 to 0.1%, by weight of the active agent is employed. The treatment is preferably repeated at intervals of between 7 to 21 days.

The active agent can be conveniently formulated as a dust, dust concentrate, wettable powder, emulsifiable concentrate or as a solution, with conventional solid or liquid adjuvants. Particularly preferred compositions of the invention are liquid concentrates, especially those containing preferably 3.0 to 50% by weight of active agent, to be diluted with water before use. Such liquid concentrate preferably includes an emulsifying agent such as a polyglycolether derived from a high molecular weight alcohol, mercaptan or alkyl phenol with an alkylene oxide as well as a diluent such as a liquid aromatic hydrocarbon or mineral oil.

Suitable solid carriers are for example ammonium salts and ground natural minerals such as kaolins, clays, talc, chalk, quartz, attapulgite, montmorillonite or diatomaceous earth, and ground synthetic materials such as highly-disperse silica, alumina and silicates; suitable solid carriers for granules are: for example crushed and fractioned natural rocks such as calcite, marble, pumice, sepiolite and dolomite, or else synthetic granules of inorganic and organic meals, and granules of organic material such as sawdust, coconut shells, maize cobs and tobacco stalks; suitable emulsifiers and/or foam formers are: for example nonionic and anionic emulsifiers such as polyoxyethylene fatty acid esters, polyoxyethylene fatty alcohol ethers, for example alkylaryl polyglycol ethers, alkylsulphonates, alkyl sulphates, arylsulphonates, or else protein hydrolysates; suitable dispersants are: for example lignin-sulphite waste liquors and methylcellulose.

Carboxymethylcellulose and natural and synthetic polymers in the form of powders, granules or latices, such as gum arabic, polyvinyl alcohol and polyvinyl acetate, or else natural phosopholipids such us cephalins and lecithins and synthetic phospholipids can be used in the formulations, Other additives can be mineral and vegetable oils. It is possible to use colorants such inorganic pigments, for example iron oxide, titanium oxide and Prussian Blue, and organic colorants such alizarin colorants, azo colorants and metal phthalocyanine colorants, and trace nutrients such as salts of iron, manganese, boron, copper, cobalt, molybdenum and zine.

The formulations generally comprise between 0.1 and 95% by weight of active compound, preferably between 0.5 and 90%.

The action of the compounds in Formula I, II and III against animal ectoparasites can be seen from the examples which follow. The examples are to be construed as merely illustrative, and not limitative of the remainder of the disclosure in any whatsoever. All of the publications cited herein are hereby incorporated by reference in their entirety.

### EXAMPLE 1

### Activity Against A. Americanum Larvae in a Dip Survival Assay

Compound 1 from a dimethyl sulfoxide (DMSO) stock or 2% DMSO alone is dispensed into a round-bottom 96-well plate and mixed with aqueous buffer containing 1% ethanol, 0.2% Triton X100. The final DMSO concentration does not exceed 2%. Larval-stage lone star ticks (Amblyomma americanum) are dispensed into the wells containing the Compound and submerged for 30 minutes. The ticks are subsequently dispensed into a tissue biopsy bag, which is allowed to dry for 1 hour. After drying, the bags are incubated at 25° with 95% humidity for 24 hours and the number of live or dead larvae are enumerated. The observations made illustrated in the following table.

| | | 0.05% | 0.01% |
|---|---|---|---|
| | 2% DMSO | Formula I | Formula I |
| Number of | 43/2 | 0/48 | 0/52 |
| live/dead | | | |
| A. americanum | | | |
| larvae 24 hours | | | |
| after treatment | | | |

What is claimed:

1-17. (canceled)

18. A method for treating a non-human mammal infested with an ectoparasite, the method comprising topically administrating to the non-human mammal a composition comprising a compound active against ectoparasites consisting of 4-chloro-3-ethyl-1-Methyl-N-[[4-(4-methylphenoxylphenyl]methyl]-1H-pyrazole-5-carboxamide or a salt thereof, wherein the ectoparasite is selected from Boophilus spp, Rhipicephalus spp, Dermacentor spp, Hyalomma spp, Amblyomma spp, Otobius spp, Ornithodorus spp, Damalinia spp, Bovicola spp or Ctenosephalides spp, and wherein the non-human mammal is selected from the group consisting of livestock, and domestic mammals.

19. The method of claim 18 wherein the composition is a solid.

20. The method of claim 18 wherein the composition is a liquid or gel.

21. The method of claim 18 wherein the administration comprises spraying, dipping, or spotting the composition onto the non-human mammal.

22. The method of claim 18 wherein the non-human mammal is selected from: cattle, sheep, goats, pigs, dogs, cats and horses.

23. The method of claim 18 wherein the topical administration comprises fitting the non-human mammal with a solid article comprising the composition.

24. The method of claim 23 wherein the solid article is selected from: a collar, a collar tag, an ear tag, a limb band or a halter.

25. The method of claim 24 wherein the solid article comprises a polymeric material.

26. The method of claim 18 wherein the ectoparasite is selected from the group consisting of ticks and flies.
